(19) United States
(12) Patent Application Publication
(10) Pub. No.: US 2025/0212284 A1
(43) Pub. Date: Jun. 26, 2025

(54) ACTIVATION AND DEACTIVATION OF THE PATH IN MULTI-PATH SCENARIO

(71) Applicant: Lenovo (Beijing) Limited, Beijing (CN)

(72) Inventors: Ran Yue, Beijing (CN); Lianhai Wu, Beijing (CN); Jing Han, Beijing (CN); Haiming Wang, Beijing (CN); Min Xu, Beijing (CN)

(73) Assignee: Lenovo (Beijing) Limited, Beijing (CN)

(21) Appl. No.: 18/849,185

(22) PCT Filed: Aug. 3, 2022
(86) PCT No.: PCT/CN2022/109995

§ 371 Date: Sep. 20, 2024

(51) Int. Cl. H04W 76/20; H04W 76/15; H04W 76/19

(52) U.S. Cl. CPC H04W 76/20; H04W 76/15; H04W 76/19

(57) ABSTRACT

Methods and apparatuses for enhancement on the indirect path are disclosed. In one embodiment, a UE (101), that is connected with a base station (102) by an indirect path via a second UE (103), comprises a processor, and a transceiver coupled to the processor; wherein, the processor is configured to identify a state of activation or deactivation of the indirect path (402), and manage the indirect path according to the state (404).

### FIELD

The subject matter disclosed herein generally relates to wireless communications, and more particularly relates to methods and apparatuses for activating and deactivating a path in multi-path scenario.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), base station (BS), user plane (UP), control plane (CP), service data adaption protocol (SDAP), Packet Data Convergence Protocol (PDCP), Sidelink Relay Adaptation Protocol (SRAP), Radio Link Control (RLC), medium access control (MAC), physical (PHY), buffer status report (BSR), control element (CE), logical channel ID (LCID), Uplink Control Information (UCI), service Data Unit (SDU), Protocol Data Unit (PDU), data radio bearer (DRB), information element (IE).

FIG. 1 illustrates a principle of multi-path scenario. As shown in FIG. 1, there are multiple (e.g. two) paths for the data transmission between UE 101 and base station (BS) (e.g. gNB) 102. Path #1 is a direct path between UE 101 and BS 102. The interface on the direct path between UE 101 and BS 102 is Uu interface. Path #2 is an indirect path between UE 101 and BS 102. It means that a relay UE 103 is included in the indirect path #2 between UE 101 and BS 102. For the indirect path #2, UE 101 is referred to as remote UE. For ease of discussion, the UE 101 in the direct path #1 can also be referred to as remote UE.

The interface between BS 102 and relay UE 103 is Uu interface. The interface between relay UE 102 and remote UE 101 may be an interface specified by 3GPP, e.g. PC5 interface. The inter connection between relay UE 102 and remote UE 101 may be ideal or non-ideal.

FIG. 2 illustrates a user plane (UP) protocol stack for the indirect path in which there are three components: a remote UE (e.g. the remote UE 101 in FIG. 1), a relay UE (e.g. the relay UE 103 in FIG. 1), and a BS (e.g. the BS 102 in FIG. 1). The user plane protocol stack for the remote UE may include Uu-SDAP, Uu-PDCP, PC5-SRAP, PC5-RLC, PC5-MAC and PC5-PHY. The user plane protocol stack for the relay UE may include PC5-SRAP, PC5-RLC, PC5-MAC, PC5-PHY, Uu-SRAP, Uu-RLC, Uu-MAC, Uu-PHY. The user plane protocol stack for the BS may include Uu-SDAP, Uu-PDCP, Uu-SRAP, Uu-RLC, Uu-MAC, Uu-PHY. The channel between the remote UE and the relay UE is PC5 relay RLC channel, and the channel between the relay UE and the BS is Uu relay RLC channel.

FIG. 3 illustrates a control plane (CP) protocol stack for the indirect path. The control plane protocol stack for the remote UE may include Uu-RRC, Uu-PDCP, PC5-SRAP, PC5-RLC, PC5-MAC and PC5-PHY. The control plane protocol stack for the relay UE may include PC5-SRAP, PC5-RLC, PC5-MAC, PC5-PHY, Uu-SRAP, Uu-RLC, Uu-MAC, Uu-PHY. The control plane protocol stack for the BS may include Uu-RRC, Uu-PDCP, Uu-SRAP, Uu-RLC, Uu-MAC, Uu-PHY. The channel between the remote UE and the relay UE is PC5 relay RLC channel, and the channel between the relay UE and the BS is Uu relay RLC channel.

The SRAP sublayer is placed above the RLC sublayer for both CP and UP at both the PC5 interface and the Uu interface. The Uu-SDAP, Uu-PDCP and Uu-RRC are terminated between the remote UE and the BS, while PC5-SRAP, PC5-RLC, PC5-MAC and PC5-PHY are are terminated between the remote UE and the relay UE, and Uu-SRAP, Uu-RLC, Uu-MAC and Uu-PHY are terminated between the relay UE and the BS. It means that SRAP, RLC, MAC and PHY are terminated in each hop (i.e. the link between the remote UE and the relay UE, and the link between the relay UE and the BS).

Once the indirect path is established, the remote UE has to monitor the indirect path no matter whether there is data transmission on the indirect path. It is possible that there is no data transmission on the indirect path for a time duration. It is not beneficial from the perspective of power consumption at remote UE to monitor the indirect path when there is no data transmission on the indirect path.

This invention targets enhancement on the indirect path.

### BRIEF SUMMARY

Methods and apparatuses for enhancement on the indirect path are disclosed.

In one embodiment, a UE, that is connected with a base station (BS) by an indirect path via a second UE, comprises a processor; and a transceiver coupled to the processor, wherein, the processor is configured to identify a state of activation or deactivation of the indirect path; and manage the indirect path according to the state.

In some embodiment, if the state of the indirect path is deactivation, the processor is configured to, when UL data arrives, manage the indirect path by activating the indirect path. The processor may be configured to activate the indirect path by sending, via the transceiver, to the second UE, an indication of data arrival or the arrived UL data. The processor may be further configured to receive, via the transceiver, from the second UE, a response to the activating the indirect path. The processor may be further configured to send, via the transceiver, to the BS, a notification of activating the indirect path.

In some embodiment, the processor is configured to identify the state of the indirect path by receiving, via the transceiver, the state of the indirect path from the BS or from the second UE.

In some embodiment, if the state of the indirect path is activation, the processor is configured to suspend the transmission on the indirect path for all radio barriers when an indication of RLF of the indirect path is received via the transceiver from the second UE.

In some embodiment, the UE is also connected with the BS by a direct path, the processor is further configured to perform RRC connection re-establishment if both the indirect path and the direct path fail, and a cause of the re-establishment is selected from: one path failure, at least one path failure, direct path failure, indirect path failure, and all paths failure.

In another embodiment, a method performed by a UE, that is connected with a base station (BS) by an indirect path via a second UE, comprises identifying a state of activation or deactivation of the indirect path; and managing the indirect path according to the state.

In a further embodiment, a second UE, that connects a first UE to a base station (BS) to form an indirect path between the first UE and the BS, comprises a processor; and a transceiver coupled to the processor, wherein, the processor is configured to receive, via the transceiver, from the BS, a state of deactivation of the indirect path; and receive, via the transceiver, from the first UE, an activation of the indirect path.

In some embodiment, the processor is further configured to transmit, via the transceiver, to the BS, an indication of the pending packet(s). The indication of the pending packets may be pending DL SDU(s) or a first un-transmitted DL packet, or a number of the first un-transmitted DL packet.

In some embodiment, the processor is further configured to send, via the transceiver, to the first UE, a response to the activation of the indirect path.

In some embodiment, the processor is further configured to send, via the transceiver, to the BS, a notification of the activation of the indirect path.

In a further embodiment, a method performed by a second UE that connects a first UE to a base station (BS) to form an indirect path between the first UE and the BS, the method comprises receiving, from the BS, a state of deactivation of the indirect path; and receiving, from the first UE, an activation of the indirect path.

In still another embodiment, a base unit, that is connected with a first UE by an indirect path via a second UE, comprises a processor; and a transceiver coupled to the processor, wherein, the processor is configured to configure, via the transceiver, the first UE to deactivate the indirect path; and indicate, via the transceiver, to the second UE of the deactivation of the indirect path to the first UE.

In some embodiment, the processor is further configured to receive, via the transceiver, from the second UE, an indication of the pending packet(s). The indication of the pending packets may be pending DL SDU(s) or a first un-transmitted DL packet, or a number of the first un-transmitted DL packet.

In yet another embodiment, a method performed by a base unit, that is connected with a first UE by an indirect path via a second UE, comprises configuring the first UE to deactivate the indirect path; and indicating to the second UE of the deactivation of the indirect path to the first UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a principle of multi-path scenario;

FIG. 2 illustrates a user plane protocol stack for the indirect path;

FIG. 3 illustrates a control plane protocol stack for the indirect path;

FIG. 4 is a schematic flow chart diagram illustrating an embodiment of a method;

FIG. 5 is a schematic flow chart diagram illustrating another embodiment of a method;

FIG. 6 is a schematic flow chart diagram illustrating a further embodiment of a method; and

FIG. 7 is a schematic block diagram illustrating apparatuses according to one embodiment.

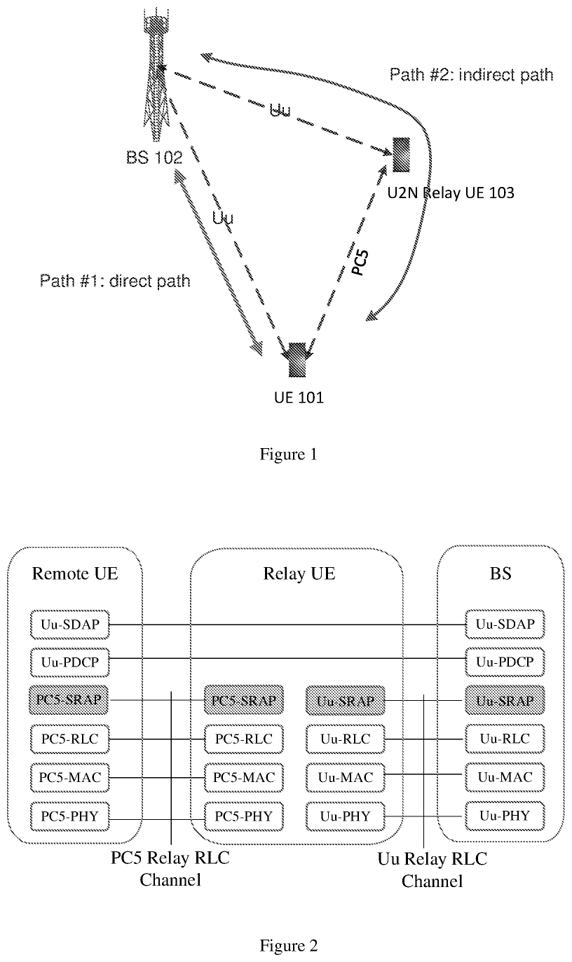

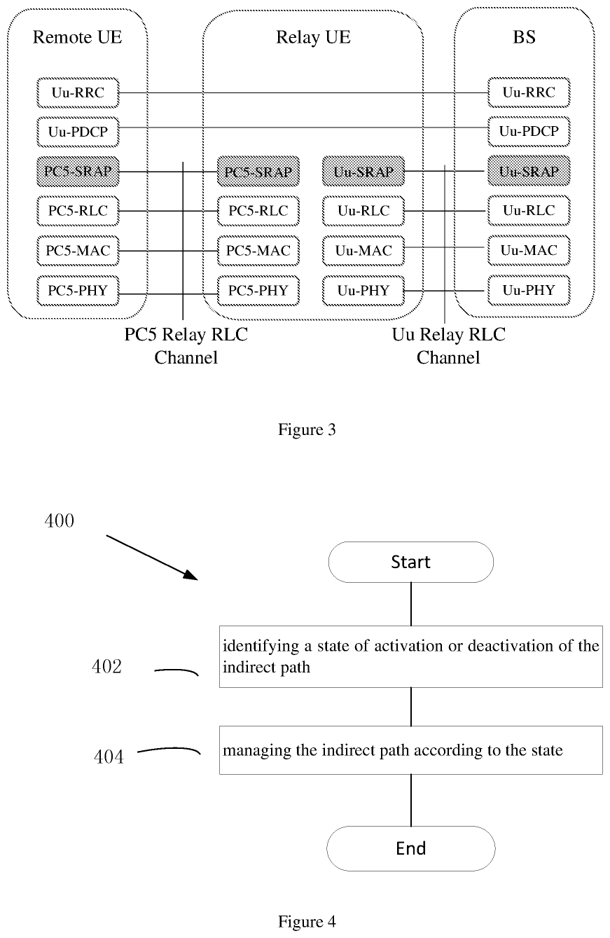

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

As mentioned in the background part, the remote UE may communicate with the BS (e.g. the gNB) via an indirect path in addition to a direct path. There can be multiple direct paths and/or multiple indirect paths between the remote UE and the BS. It means that the paths between the remote UE and the BS include at least one direct path and at least one indirect path. To make simplification, in the following description, the paths between the remote UE and the BS include only one direct path and one indirect path.

For the indirect path, the data is forwarded via the relay UE between the remote UE and the BS.

The connection between the remote UE and the relay UE may be referred to as sidelink. A set of transmission and reception resource pools for sidelink control information and for data when the remote UE is out of coverage for sidelink communication is pre-configured in the remote UE. In addition, the resource pools for sidelink control information and for data when the UE is in coverage for sidelink communication are configured by the BS.

In addition, a subset of resource pool can be configured for saving the monitoring overhead. It means the UE can receive and/or transmit control information and data with the resource pool, but only monitor a subset of the resource pool when there is no control information and data being communicated.

As shown in the background part in FIG. 1, the indirect path is described as a path between UE 101 (referred to as remote UE) and BS 102 via relay UE 103. In this disclosure, the indirect path is a path between a first UE and BS via a second UE. In other words, the remote UE and the relay UE can be any two UEs. It means that the interface between two UEs (i.e. the first UE and the second UE) may be an interface not specified by 3GPP. For example, an example of the two UEs may be a smart phone and a smart watch. The interface between the smart phone and the smart watch is not specified in 3GPP. Incidentally, it is possible that the interface between the two UEs (e.g. the smart phone and the smart watch) will be specified in 3GPP in the future. Further, the two UEs may belong to one person or different persons.

In the following description, for ease of discussion, the first UE and the second UE are described as remote UE and relay UE.

A first embodiment relates to the remote UE activating the indirect path in the condition that the indirect path is deactivated.

When the indirect path is deactivated, the remote UE may stop monitoring the resource pool for the indirect path to the relay UE. If a subset of resource pool is configured for the indirect path to the relay UE, the remote UE stops monitoring the subset of source pool when the indirect path is deactivated.

In the condition that the indirect path is deactivated, the remote UE may activate the indirect path, e.g. via the indirect path or via the direct path.

According to a first sub-embodiment of the first embodiment, the remote UE activates the indirect path via the indirect path. In the first sub-embodiment, it is assumed that, in the indirect path, the Uu interface between the relay UE and the BS is always activated. It means that even the indirect path is deactivated from the view of the remote UE (i.e. the remote UE does not monitor the indirect path), the Uu interface between the relay UE and the BS is still activated for the indirect path.

The remote UE activates the indirect path by indicating the UL data arrival to the relay UE or by transmitting the arrived UL data directly to the relay UE.

When the UL data arrives at the remote UE, the remote UE may indicate the UL data arrival to the relay UE (e.g. by a message of indication) or transmit the arrived UL data directly to the relay UE.

The message of indication may be a PC-5 message from the remote UE to the relay UE, e.g. a PC-5 BSR (buffer status report). The PC-5 message may be a MAC CE, or a LCID, or UCI, or physical sidelink control information.

Alternatively, the message of indication may be a Uu message from the remote UE to the relay UE. The Uu message may be a RRC message, or a MAC CE, or a LCID, or UCI. In this condition, the relay UE receives the Uu message of indication on the PC-5 interface. The relay UE has two options after receiving the Uu message of indication on the PC-5 interface. In a first option, the relay UE forwards the Uu message of indication to the BS. In a second option, the UE obtaining the message of indication by removing the PC-5 header of the Uu message of indication, and forwarding the Uu message of indication into the Uu protocol stack of the relay UE itself.

In response to receiving the message of indication (indicating the UL data arrival) (e.g. by receiving a PC-5 message of indication, or by receiving a Uu message of indication and obtaining the message of indication) or receiving the arrived UL data from the remote UE, the relay UE may send a response to the remote UE to confirm the activation of the indirect path.

It can be seen that the activation of the indirect path is determined by the remote UE (e.g. by sending the message of indication or the arrived UL data to the relay UE) or the relay UE (e.g. by sending a confirmation of the activation of the indirect path to the remote UE), but not by the BS (e.g. the gNB). In view of the above, after the activation of the indirect path, the remote UE or the relay UE notifies the BS of the activation of the indirect path via Uu interface.

If the relay UE forwards the received Uu message of indication to the BS, the BS indicates or configures, to the relay UE, the activation of the indirect path of the remote UE. The indication or configuration includes at least the ID of the remote UE. The indication or configuration may be a new IE, or a new RRC message, or a new MAC CE, or a new LCID.

According to a second sub-embodiment of the first embodiment, the remote UE activates the indirect path via the direct path.

The remote UE may indicate the arrival of UL data on the direct path to the BS.

Upon receiving the indication from the remote UE, the BS indicates or configures, to the relay UE, the activation of the indirect path of the remote UE. The indication or configuration includes at least the ID of the remote UE. The indication or configuration may be a new IE, or a new RRC message, or a new MAC CE, or a new LCID. Incidentally, the same process as the activation of the indirect path can be applied to the deactivation of the indirect path.

In addition, upon receiving the indication from the remote UE, the BS sends, to the remote UE, a response to confirm the activation of the indirect path. The response may be an RRC reconfiguration, or a new RRC message, or a new MAC CE, or a new LCID, or a resource allocation for sidelink transmission.

According to the first embodiment, when UL data arrives, if the indirect path is in the state of deactivation, the remote UE may activate the indirect path. To support deactivation of the indirect path, the relay UE should ensure that there is no pending SDUs or PDUs remaining in the RLC entity of the relay UE (which means the SDUs or PDUs that have not been successfully sent to the remote UE or to the BS). In addition, since there is no BSR over PC-5 interface, the relay UE has no understanding on whether the remote UE will transmit new data before the relay UE indicates the gNB of no pending SDUs or PDUs in RLC entity.

A second embodiment relates to ensuring that there is no pending SDUs or PDUs over PC-5 interface when deactivating the indirect path.

According to a first sub-embodiment of the second embodiment, the remote UE indicates the last UL packet of the DRB(s) configured to the indirect path to the relay UE, so that the relay UE understands there is no pending UL packet(s) on the indirect path from the remote UE. The indication can be enabled by the configuration from the BS or requested by the relay UE or gNB. The indication may be a MAC CE, or a LCID, or a RLC control PDU, or being included in RLC header.

According to a second sub-embodiment of the second embodiment, the BS reconfigures the remote UE to deactivate the indirect path. It means that the remote UE does not monitor the indirect path. In addition, the BS indicates the relay UE to deactivate the indirect path to the remote UE. The indication includes at least of the ID the remote UE.

Upon receiving the indication to deactivate the indirect path of the remote UE, the relay UE transmits the pending DL SDUs back to the BS to enable the BS retransmission of the DL packets on the direct path, if it is assumed that UL packets can be transmitted to the BS at any time. Alternatively, the relay UE sets a different number to each of the RLC packets receiving from the gNB to the remote UE when transmitting over the indirect path, and indicates the number of a first un-transmitted DL packet to the gNB or sends back the first un-transmitted DL packet to the gNB. Incidentally, the un-transmitted DL packet may refer to both the un-transmitted DL packet to the remote UE and un-acknowledged DL packet by the remote UE.

A third sub-embodiment of the second embodiment relates to a special case in which the relay UE has a connection to only one remote UE.

For UL packets, the relay UE indicates to the remote UE to transmit the last packet(s) of the DRB. Alternatively, the relay UE or the gNB indicates to the remote UE to stop the UL transmission.

In addition, the relay UE may notify the end of UL transmission to the BS, after the last packet(s) of the DRB from the remote UE have been transmitted to the BS.

For the activated indirect path, it is possible that the relay UE declares RLF (radio link failure), for example, because of RLC failure on Uu interface between relay UE and BS. In this condition, it is necessary to determine whether RRC re-establishment should be made.

A third embodiment relates to the remote UE behavior when the direct path and/or the indirect path fail.

According to a first embodiment of the third embodiment, when the indirect path fails (e.g. the indication of RLF of the indirect path is received from the relay UE), if the direct path does not fail, the remote UE suspends the transmissions on the indirect path for all radio bearers.

On the other hand, when the direct path fails, if the indirect path does not fail, the remote UE suspends the transmissions on the direct path for all radio bearers. The remote UE transmits the failure information of the direct path to the BS via the indirect path. The failure information can be a PC-5 message or Uu RRC message. The failure cause can be one path failure or at least one path failure or direct path failure or all other paths failure.

According to a second embodiment of the third embodiment, when the indirect path fails (e.g. the indication of RLF of the indirect path is received from the relay UE), the remote UE may perform RRC connection re-establishment. The re-establishment cause can be indirect path failure.

Optionally, only when both the direct path and the indirect path fail, the remote UE may perform RRC connection re-establishment. The re-establishment cause can be all paths failure.

Optionally, if the remote UE receives the indication of RLF of the indirect path from the relay UE, the remote UE starts a timer. If no indication is received from the direct path or from the indirect path before the timer expires, the remote UE may perform RRC connection re-establishment. The indication from the direct path or from the indirect path may be an RRC reconfiguration message, and the indication may deactivate or release the indirect path. If the indication is received, the remote UE stops the timer and does not perform RRC connection re-establishment.

FIG. 4 is a schematic flow chart diagram illustrating an embodiment of a method 400 according to the present application. In some embodiments, the method 400 is performed by an apparatus, such as a remote unit (UE). In certain embodiments, the method 400 may be performed by a processor executing program code, for example, a microcontroller, a microprocessor, a CPU, a GPU, an auxiliary processing unit, a FPGA, or the like.

The method 400 may be performed by a UE that is connected with a base station (BS) by an indirect path via a second UE. The method 400 comprises 402 identifying a state of activation or deactivation of the indirect path; and 404 managing the indirect path according to the state.

In some embodiment, if the state of the indirect path is deactivation, the method comprises, when UL data arrives, managing the indirect path by activating the indirect path. Further, the method comprises activating the indirect path by sending, to the second UE, an indication of data arrival or the arrived UL data. The method may further comprise receiving from the second UE a response to the activating the indirect path. The method may further comprise sending to the BS a notification of activating the indirect path.

In some embodiment, the method comprises identifying the state of the indirect path by receiving the state of the indirect path from the BS or from the second UE.

In some embodiment, if the state of the indirect path is activation, the method comprises suspending the transmission on the indirect path for all radio barriers when an indication of RLF of the indirect path is received from the second UE.

In some embodiment, the UE is also connected with the BS by a direct path, the method further comprises performing RRC connection re-establishment if both the indirect path and the direct path fail, and a cause of the re-establishment is selected from: one path failure, at least one path failure, direct path failure, indirect path failure, and all paths failure.

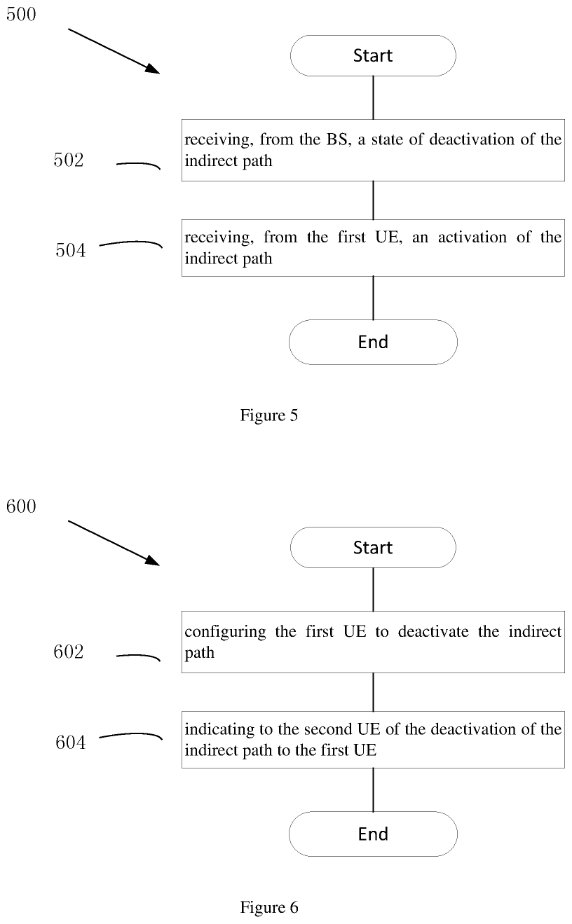

FIG. 5 is a schematic flow chart diagram illustrating an embodiment of a method 500 according to the present application. In some embodiments, the method 500 is performed by an apparatus, such as a remote unit (UE). In certain embodiments, the method 500 may be performed by a processor executing program code, for example, a microcontroller, a microprocessor, a CPU, a GPU, an auxiliary processing unit, a FPGA, or the like.

The method 500 may be performed by a second UE that connects a first UE to a base station (BS) to form an indirect path between the first UE and the BS, the method comprises 502 receiving, from the BS, a state of deactivation of the indirect path; and 504 receiving, from the first UE, an activation of the indirect path.

In some embodiment, the method further comprises transmitting, to the BS, an indication of the pending packet(s). The indication of the pending packets may be pending DL SDU(s) or a first un-transmitted DL packet, or a number of the first un-transmitted DL packet.

In some embodiment, the method further comprises sending, to the first UE, a response to the activation of the indirect path.

In some embodiment, the method further comprises sending, to the BS, a notification of the activation of the indirect path.

FIG. 6 is a schematic flow chart diagram illustrating a further embodiment of a method 600 according to the present application. In some embodiments, the method 600 is performed by an apparatus, such as a base station or a network device. In certain embodiments, the method 600 may be performed by a processor executing program code, for example, a microcontroller, a microprocessor, a CPU, a GPU, an auxiliary processing unit, a FPGA, or the like.

The method 600 may be performed by a base station that is connected with a first UE by an indirect path via a second UE. The method 600 comprises 602 configuring the first UE to deactivate the indirect path; and 604 indicating to the second UE of the deactivation of the indirect path to the first UE.

In some embodiment, the method further comprises receiving, from the second UE, an indication of the pending packet(s). The indication of the pending packets may be pending DL SDU(s) or a first un-transmitted DL packet, or a number of the first un-transmitted DL packet.

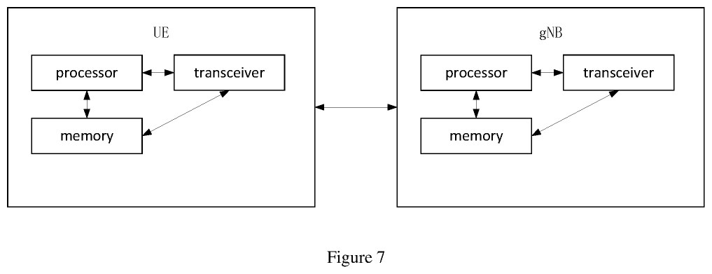

FIG. 7 is a schematic block diagram illustrating apparatuses according to one embodiment.

Referring to FIG. 7, the UE (i.e. remote unit, or terminal device) includes a processor, a memory, and a transceiver. The processor implements a function, a process, and/or a method which are proposed in FIG. 4 or FIG. 5.

The UE is connected with a base station (BS) by an indirect path via a second UE, the UE comprises a processor; and a transceiver coupled to the processor, wherein, the processor is configured to identify a state of activation or deactivation of the indirect path; and manage the indirect path according to the state.

In some embodiment, if the state of the indirect path is deactivation, the processor is configured to, when UL data arrives, manage the indirect path by activating the indirect path. The processor may be configured to activate the indirect path by sending, via the transceiver, to the second UE, an indication of data arrival or the arrived UL data. The processor may be further configured to receive, via the transceiver, from the second UE, a response to the activating the indirect path. The processor may be further configured to send, via the transceiver, to the BS, a notification of activating the indirect path.

In some embodiment, the processor is configured to identify the state of the indirect path by receiving, via the transceiver, the state of the indirect path from the BS or from the second UE.

In some embodiment, if the state of the indirect path is activation, the processor is configured to suspend the transmission on the indirect path for all radio barriers when an indication of RLF of the indirect path is received via the transceiver from the second UE.

In some embodiment, the UE is also connected with the BS by a direct path, the processor is further configured to perform RRC connection re-establishment if both the indirect path and the direct path fail, and a cause of the re-establishment is selected from: one path failure, at least one path failure, direct path failure, indirect path failure, and all paths failure.

A second UE connects a first UE to a base station (BS) to form an indirect path between the first UE and the BS. The second UE comprises a processor; and a transceiver coupled to the processor, wherein, the processor is configured to receive, via the transceiver, from the BS, a state of deactivation of the indirect path; and receive, via the transceiver, from the first UE, an activation of the indirect path.

In some embodiment, the processor is further configured to transmit, via the transceiver, to the BS, an indication of the pending packet(s). The indication of the pending packets may be pending DL SDU(s) or a first un-transmitted DL packet, or a number of the first un-transmitted DL packet.

In some embodiment, the processor is further configured to send, via the transceiver, to the first UE, a response to the activation of the indirect path.

In some embodiment, the processor is further configured to send, via the transceiver, to the BS, a notification of the activation of the indirect path.

Referring to FIG. 7, the gNB (i.e. base station or network device) includes a processor, a memory, and a transceiver. The processor implements a function, a process, and/or a method which are proposed in FIG. 6.

The base station (BS) comprises a processor; and a transceiver coupled to the processor, wherein, the processor is configured to configure, via the transceiver, the first UE to deactivate the indirect path; and indicate, via the transceiver, to the second UE of the deactivation of the indirect path to the first UE.

In some embodiment, the processor is further configured to receive, via the transceiver, from the second UE, an indication of the pending packet(s). The indication of the pending packets may be pending DL SDU(s) or a first un-transmitted DL packet, or a number of the first un-transmitted DL packet.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
the at least one processor coupled with the at least one memory and configured to cause the UE to:
identify a state of activation or deactivation of a direct path by which the UE is connected with a base station (BS) and an indirect path by which the UE is connected with the BS via a second UE; and
perform a radio resource control (RRC) connection re-establishment if both of the direct path and the indirect path fail.

2. The UE of claim 1, wherein, if the state of the indirect path is deactivation, the at least one processor is configured to cause the UE to: receive uplink (UL) data, and activate the indirect path.

3. The UE of claim 2, wherein, to activate the indirect path, the at least one processor is configured to cause the UE to transmit, to the second UE, an indication of data arrival or the received UL data.

4. The UE of claim 2, wherein the at least one processor is further configured to cause the UE to receive, from the second UE, a response to the activate the indirect path.

5. The UE of claim 2, wherein the at least one processor is further configured to cause the UE to transmit a notification of activating the indirect path.

6. The UE of claim 1, wherein, to identify the state of the indirect path, the at least one processor is configured to cause the UE to receive the state of the indirect path from the BS or from the second UE.

7. The UE of claim 1, wherein, if the state of the indirect path is activation, the at least one processor is configured to cause the UE to suspend transmission on the indirect path for all radio barriers when an indication of radio link failure (RLF) of the indirect path is received from the second UE.

8. The UE of claim 1, wherein the RRC connection re-establishment is based at least in part on one of one path failure, at least one path failure, direct path failure, indirect path failure, or all paths failure.

9. A second user equipment (UE) for wireless communication, comprising:
at least one memory; and
at least one processor coupled with the at least one memory and configured to cause the second UE to:
receive from a base station (BS), a state of deactivation of an indirect path by which the second UE connects a first UE to the BS; and
receive from the first UE, an activation of the indirect path.

10. The second UE of claim 9, wherein the at least one processor is further configured to cause the second UE to transmit, to the BS, an indication of one or more pending data packets.

11. The second UE of claim 10, wherein the indication of the one or more pending data packets is at least one of one or more pending downlink (DL) service data units (SDUs), a first un-transmitted DL packet, or a number of the first un-transmitted DL packet.

12. The second UE of claim 9, wherein the at least one processor is further configured to cause the second UE to transmit, to the first UE, a response to the activation of the indirect path.

13. The second UE of claim 9, wherein the at least one processor is further configured to cause the second UE to transmit, to the BS, a notification of the activation of the indirect path.

14. A base station (BS) for wireless communication, comprising:
at least on memory; and
at least one processor coupled with the at least one memory and configured to cause the BS to:
configure a first user equipment (UE) to deactivate an indirect path, the BS connected with the first UE by the indirect path via a second UE; and
indicate to the second UE of the deactivation of the indirect path to the first UE.

15. The base station of claim 14, wherein the at least one processor is further configured to cause the BS to receive, from the second UE, an indication of one or more pending data packets.

16. A processor for wireless communication, comprising:
at least one controller coupled with at least one memory and configured to cause the processor to:
identify a state of activation or deactivation of a direct path by which a first user equipment (UE) is connected with a base station (BS) and an indirect path by which the first UE is connected with the BS via a second UE; and
perform a radio resource control (RRC) connection re-establishment if both of the direct path and the indirect path fail.

17. The processor of claim 16, wherein, if the state of the indirect path is deactivation, the at least one controller is configured to cause the processor to receive uplink (UL) data, and activate the indirect path.

18. The processor of claim 17, wherein, to activate the indirect path, the at least one controller is configured to cause the processor to transmit, to the second UE, an indication of data arrival or the received UL data.

19. The processor of claim 17, wherein, the at least one controller is configured to cause the processor to receive, from the second UE, a response to the activate the indirect path.

20. The processor of claim 17, wherein the at least one controller is configured to cause the processor to transmit a notification of activating the indirect path.
